(19) United States
(12) Patent Application Publication
(10) Pub. No.: US 2009/0110011 A1
(43) Pub. Date: Apr. 30, 2009

(54) OPTICAL COMPONENT FOR LASER BEAM

(75) Inventors: Yasuhisa NISHIKAWA, Koriyama-shi (JP); Koichi Murata, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Chiyoda-ku (JP)

(21) Appl. No.: 12/343,963

(22) Filed: Dec. 24, 2008

Related U.S. Application Data
(63) Continuation of application No. PCT/JP07/62223, filed on Jun. 18, 2007.

(30) Foreign Application Priority Data
Jun. 26, 2006 (JP) 2006-175461

(51) Int. Cl. H01S 3/098

(52) U.S. Cl. 372/19

(57) ABSTRACT

The present invention is to suppress deterioration of durability at the time when an optical component using a material optimized to be used in an optical path of a laser beam for performing reproduction/recording for a CD and a DVD is used in an optical head device using light sources including a blue semiconductor laser. A first transparent substrate 1 and a second transparent substrate 2 sandwich and hold therebetween a concave-convex portion 5 comprising a polymer liquid crystal, a filling adhesive 7 for filling the concave-convex, and a phase plate 6 having a retardation corresponding to ¼ of a wavelength used. An inorganic optical multilayer film 3 is formed on the whole surface of the first transparent substrate 1, on the side opposite to the concave-convex portion 5, and an inorganic optical multilayer film 4 is formed on the whole surface of the second transparent substrate 2, on the side opposite to the concave-convex portion 5. The formation of the optical multilayer film 4 reduces the intensity of light of 400 to 410 nm which enters the second transparent substrate 2 to 20% or less of that of light which enters the optical multilayer film.

### TECHNICAL FIELD

The present invention relates to an optical component for a laser beam, and an optical head device using the same.

### BACKGROUND ART

In a compatible optical head device for performing reproduction and/or recording (“reproduction and/or recording” is hereinafter abbreviated as “reproduction/recording”) of information for optical recording media having different standards such as a BD (a next-generation DVD which performs reproduction and/or recording with a blue semiconductor laser, represented by a Blu-ray or an HD-DVD), a DVD and a CD, development of reduction in size and weight of the device has been actively conducted.

In the BD, DVD and CD having different standards, the wavelength of a laser beam used for reproduction/recording thereof is different. A wavelength range of 405 nm is used for the BD, a wavelength range of 660 nm for the DVD, and a wavelength range of 785 nm for the CD. In order to reduce the size and weight of the compatible optical head device interchangeably using these optical recording media having different standards, a three-wavelength semiconductor laser which emits laser beams of the above-mentioned three wavelength ranges has been developed.

In such a compatible optical head device, an optical component arranged in an optical path of a laser beam for performing reproduction/recording for the CD and DVD and an optical component arranged in an optical path of a laser beam for performing reproduction/recording for the BD are made different from each other in their materials used in some cases. For CD and DVD application, a material with which durability and high performance are compatible with each other with respect to the beams of the DVD and CD wavelength ranges has already been developed. However, for BD application, the same material is not necessarily sufficient with respect to the beam of the blue color (BD) wavelength range in some cases. Conversely, when a material excellent in light resistance for BD application is used for DVD and CD application, it is insufficient yet in respect to performance for DVD and CD application in some cases.

For example, of polymer liquid crystals used as polarization diffraction gratings, a material high in durability to the blue semiconductor laser which performs reproduction/recording for the BD is not so high in refractive index anisotropy. In order to obtain necessary diffraction efficiency, it is necessary to thicken a polymer liquid crystal layer, or the like.

As an example of a material in which durability and characteristics are made compatible with each other for CD and DVD application, reference can be made to patent document 1. Further, as an example of a material having increased durability, although being not so high in refractive index anisotropy, reference can be made to patent document 2.

Patent Document 1: JP-A-2001-220583

Patent Document 2: WO 2006/001096

### DISCLOSURE OF THE INVENTION

### Problems to be Solved by the Invention

It was found that there is a phenomenon that even an optical component using a material optimized to be used in an optical path of a laser beam for performing reproduction/recording for a CD and a DVD becomes inferior in durability when used in a three-wavelength compatible optical head device for a CD, a DVD and a BD, as compared to when used in a conventional compatible optical head device for a CD and a DVD. That is, even an optical component using a material optimized to be used in an optical path of a laser beam for performing reproduction/recording for a CD and a DVD can not exhibit intrinsic durability and characteristics in a three-wavelength compatible optical head device for a CD, a DVD and a BD.

The invention has been made for suppressing deterioration of durability at the time when an optical component using a material optimized to be used in an optical path of a laser beam for performing reproduction/recording for a CD and a DVD is used in a three-wavelength compatible optical head device using a light source containing a blue semiconductor laser.

### Means for Solving the Problems

The invention provides an optical component for a laser beam at least partially comprising an organic material, and having, provided over a substantially whole surface of at least one light incident face, a blue light blocking means that has a transmission of light having a wavelength of 400 to 410 nm of 20% or less and a transmission of light having a wavelength of 600 to 800 nm of 60% or more. Further, there is provided an optical component for a laser beam at least partially comprising an organic material, and having, provided over a substantially whole surface of at least one light incident face, a blue light blocking means that has a transmission of light having a wavelength of 400 to 410 nm of 20% or less and a transmission of light having wavelengths of 640 to 690 nm and 760 to 800 nm of 60% or more.

According to this constitution, even when the optical component using a material optimized to be used in an optical path of a laser beam for performing reproduction/recording for a CD and a DVD is used in an optical head device using light sources including a blue semiconductor laser, deterioration of durability can be suppressed by the present invention.

Further, there is provided the above-mentioned optical component for a laser beam, wherein the a blue light blocking means has a transmission of light having a wavelength of 400 to 410 nm of 20% or less over a substantially whole surface of at least one light incident face, and the surface opposite to the above-mentioned light incident face a transmission of light having a wavelength of 400 to 410 nm of 60% or more.

According to this constitution, even when the light having a wavelength of 400 to 410 nm enters from the light incident face having low transmission, and passes through the optical component for a laser beam with the amount of light reduced, the incident light does not happen to oscillate in the optical component for a laser beam, because the transmission of the opposite surface is high. Accordingly, the deterioration of durability can be further suppressed.

Furthermore, there is provided the above-mentioned optical component for a laser beam, wherein the blue light blocking means is an inorganic multilayer film provided on the light incident face of the optical component for a laser beam.

According to this constitution, the transmission of the light having a wavelength of 400 to 410 nm can be sufficiently decreased, while practically sufficiently increasing the transmission of the light having a wavelength of 600 to 800 nm.

In addition, there is provided the above-mentioned optical component for a laser beam, wherein at least one light incident face different from the light incident face on which the blue light blocking means is provided has a transmission of light having a wavelength of 350 to 375 nm of 20% or more.

According to this constitution, it becomes possible to employ a procedure such as ultraviolet curing by irradiation of an ultraviolet ray having a wavelength of about 350 to 375 nm, during a production process of the optical component for a laser beam.

### Advantageous Effects of the Invention

According to the optical component for a laser beam of the invention, deterioration of durability at the time when the optical component using a material optimized to be used in an optical path of a laser beam for performing reproduction/recording for a CD and a DVD is used in an optical head device using light sources including a blue semiconductor laser can be suppressed.

### BRIEF DESCRIPTION OF THE DRAWINGS

FIG. 1 is a cross-sectional view showing a polarization hologram that is an optical component of the invention.

FIG. 2 is a graph showing deterioration of an optical characteristic in an example of the invention.

FIG. 3 is a graph showing deterioration of an optical characteristic in a comparative example of the invention.

FIG. 4 is a schematic view showing an example of an optical arrangement of an optical head device using an optical component of the invention.

### DESCRIPTION OF REFERENCE NUMERALS AND SIGNS

1, 2: Transparent Substrates

3, 4: Optical Multilayer Films

5: Concave-Convex Portion

6: Phase Plate

7: Filling Adhesive

### BEST MODE FOR CARRYING OUT THE INVENTION

Generally, organic materials are characterized in having high degree of freedom in design of optical characteristics. Accordingly, an optical component at least partially comprising an organic material and containing it as a constituent component has high degree of freedom in the design of optical characteristics, so that optimum optical characteristics according to respective optical device used are easily obtained.

Of such organic materials, particularly, a liquid crystal material has a very wide application range as the optical component, because it generally has birefringence and the quantity and direction of the birefringence can be controlled by an external field such as an electric field or a magnetic field. Further, a polymer liquid crystal material obtained by polymerizing a monomer or oligomer having liquid crystallinity is very useful as a material constituting the optical component, because the direction of refractive index anisotropy of the polymer liquid crystal material can be freely controlled by controlling an orientation direction of liquid crystal at the time of polymerization.

One feature of the invention is that the optical component of the invention has a blue light blocking means. As for light transmission characteristics of the blue light blocking means, the transmission is 20% or less for light having a wavelength of 400 to 410 nm, and the transmission is 60% or more for light having a wavelength of 600 to 800 nm. The present inventors have made intensive studies on the cause of deterioration of durability at the time when the optical component using a material optimized to be used in an optical path of a laser beam for performing reproduction/recording for a CD and a DVD is used in an optical head device using light sources including a blue semiconductor laser. As a result, it was found that stray light of the blue laser arrives at the optical component for the CD and DVD, which causes deterioration of the organic material used in the optical component.

Accordingly, selective blocking of blue light on an incident face of the optical component suppresses reach of the blue stray light to the organic material portion constituting the optical component, thereby being able to suppress deterioration of the organic material. The transmission of the light having a wavelength of 400 to 410 nm is preferably 5% or less, and more preferably 1% or less. Further, the transmission of the light having a wavelength of 600 to 800 nm is preferably 80% or more, and more preferably 90% or more. Further, in the case where it is better to narrow the wavelength range of 600 to 800 nm because of the increased degree of freedom in design of light blocking means, the transmission of light within the wavelength range narrower than the range of 600 to 800 nm, such as the wavelength range of 640 to 690 nm substantially used for a DVD or the wavelength range of 760 to 800 nm for a CD, may be adjusted to 80% or more, and more preferably to 90% or more.

The blue light blocking means in the invention is provided over a substantially whole surface of a light incident face of the optical component. The term “a substantially whole surface” as used herein means a whole surface to the extent that incidence of the stray light into the optical component is inhibited to extend the life of the organic material, thereby being able to stand practical use. The stray light enters the optical component from the light incident side of the optical component in many cases, so that the blue light blocking means is preferably provided at least on the light incident face on the blue light source side of the optical component. However, the blue light blocking means may be provided over a substantially whole surface also for any light incident face other than that on the blue light source side.

Further, in order to effectively inhibit incidence of the stray light, the blue light blocking means is preferably provided in contact with the light incident face of the optical component for a laser beam. However, this does not mean to preclude that the blue light blocking means is provided apart from the light incident face of the optical component for a laser beam. Of course, when the blue light blocking means is provided apart from the optical component for a laser beam, it is preferably provided in as close proximity to the light incident face as possible so that the stray light does not enter from the distant part.

Typical specific examples of the blue light blocking means include an inorganic multilayer film formed on the light incident face of the optical component. As the inorganic multilayer film, for example, a wavelength-selective dielectric multilayer film in which a high refractive index dielectric film comprising TiO₂, Ta₂O₅ or the like and a low refractive index dielectric film comprising SiO₂ or the like are alternately laminated can be used on the light incident face. Such a dielectric multilayer film can be formed by vacuum deposition or spattering.

From the viewpoints of improving the transmission of the light having a wavelength of 600 to 800 nm and increasing the transmission of the optical component at a wavelength used, it is preferred that the inorganic multilayer film has in addition an antireflection function at the wavelength at which the optical component is used. For example, in the optical component used in an optical head device compatibly used at two wavelengths for DVD and BD, the inorganic multilayer film is designed so as to have the antireflection function at a wavelength of 645 to 675 nm. Further, in the optical component used in an optical head device compatibly used at two wavelengths for CD and BD, the inorganic multilayer film is designed so as to have the antireflection function at a wavelength of 770 to 800 nm.

The blue light blocking means is not limited to the inorganic multilayer film provided on the surface of the optical component as described above, and may be any as long as it has the light transmission characteristics of the invention. Glass containing a blue light absorption component such as cerium oxide or trivalent iron can also be used depending on the application of the optical component.

Further, it is also possible to provide the blue light blocking means as a separate body from the optical component for a laser beam. In this case, the blue light blocking means can be formed by providing the above-mentioned inorganic multilayer film on a transparent substrate, or the like. In addition, the term “transparent” as used herein does not require exhibiting sufficient light transmission over the whole visible light region, but needs only exhibit light transmission necessary for the optical component at least at the wavelength of light at which the optical component is used. As a material for the substrate, an optically isotropic material is preferred. Further, in terms of durability, an inorganic material such as glass, quartz crystal or quartz is preferred.

The optical component for a laser beam of the invention is not limited, as long as it is an optical component used in an optical path of a laser beam. Examples thereof include, for example, a lens, a hologram (including a polarization hologram), a retardation film, a diffraction grating, a prism, a filter, a mirror, a liquid crystal optical element (for example, one containing any one of functions such as an aberration correction function, a wavefront control function, a polarization state control function, a transmission variable function and a diffraction efficiency variable function), a light absorption element and a sensor lens.

Further, examples of the organic materials used in the optical component of the invention include an acrylic resin, a polycarbonate resin, a cycloolefinic resin, a fluororesin, a transparent polyimide resin, an epoxy-based resin, a styrenic resin and the like, and particularly, an organic material having absorption to light in the 400 nm is range. In addition to these, there are the liquid crystal materials, particularly the polymer liquid crystal materials, as described above. Examples of such polymer liquid crystal materials include those described in JP-A-2001-220583. In particular, polymer liquid crystals obtained by polymerizing a polymerizable composition containing a compound having —Ph—CO— (wherein Ph represents a 1,4-phenylene group) or tolan are preferred, because of their large refractive index anisotropy and high durability.

Further, in the optical component of the invention, it is preferred that at least one light incident face different from the light incident face on which the blue light blocking means is provided has a transmission of light having a wavelength of 350 to 375 nm of 20% or more. According to this, it becomes possible to employ a procedure such as ultraviolet curing by irradiation of an ultraviolet ray during a production process of the optical component. The transmission of the light having a wavelength of 350 to 375 nm is preferably 50% or more.

In this case, the light incident face having a transmission of light having a wavelength of 350 to 375 nm of 20% or more is preferably arranged on a side other than the blue laser source side, in which there will be less stray light of blue light. Further, even in such a light incident face having a transmission of light having a wavelength of 350 to 375 nm of 20% or more, it is preferred that the transmission of light having a wavelength of 310 nm or less is reduced to 5% or less, from the viewpoint of suppressing deterioration of the organic material used in the optical component. The transmission of the light having a wavelength of 310 nm or less is preferably 1% or less, and more preferably 0.5% or less.

Furthermore, the reflectance at 400 to 410 nm of at least one light incident face different from the light incident face on which the blue light blocking means is provided is preferably 70% or less, more preferably 50% or less, and particularly preferably 30% or less. When the blue light which has slightly filtered in from the light incident face on which the blue light blocking means is provided passes through an element and reaches a surface different from the incident face, reflection of the blue light on that surface causes the blue light to reciprocate in the element, whereby the blue light in the element is confined to increase optical density. The above-mentioned preferred embodiment is effective for preventing such confinement of the light. That is, it is preferred to prevent the confinement of the blue light filtered in from the incident face passing through the blue light blocking means, by reducing the reflection at the surface different from the incident face.

The blue light blocking means having a characteristic that the transmission of light of 400 to 410 nm is low is preferably applied to the surface through which the blue light enters. When the opposite side also has such a characteristic that the transmission is similarly low, the light which has passed through the incident face of the blue light blocking means is confined not a little to cause oscillation, which brings about a concern of a decrease in reliability. Accordingly, it is preferred that the surface which the light of 400 to 410 nm enters has a transmission of 20% or less, and that the opposite surface has a transmission of 60% or more to the light of 400 to 410 nm.

When a titanium oxide TiO₂ or TiOₓ (1.5≦x≦1.99) is used as the multilayer film, it is preferred to set the transmission at 400 to 410 nm of the incident face of the blue light blocking means to 20% or less, the reflectance to 40% or less, and the remainder to be the absorptance, because a decrease in reliability by the oscillation due to the confinement of the light which has passed through the incident face can be avoided.

The optical component for a laser beam of the invention is preferably used as an optical system of an optical head device using a laser beam having a wavelength of 400 to 410 nm and a laser beam having a wavelength of 600 nm or more. That is, when it is arranged at a portion in an optical path of the laser beam having a wavelength of 600 nm or more and outside an optical path of the laser beam having a wavelength of 400 to 410 nm, less stray light of the light having a wavelength of 400 to 410 nm reaches the organic material portion of the optical component. Accordingly, a long-lived optical head device can be obtained. In this case, as described above, the light incident face provided with the blue light blocking means having a transmission of 20% or less for the light having a wavelength of 400 to 410 nm and a transmission of 60% or more for the light having a wavelength of 600 to 800 nm is preferably arranged on the light source side of the laser beam having a wavelength of 400 to 410 nm. Further, for the surface opposite to the light source side of the laser beam having a wavelength of 400 to 410 nm, the blue light blocking means having a transmission of 20% or less for the light having a wavelength of 400 to 410 nm and a transmission of 60% or more for the light having a wavelength of 600 to 800 nm may be provided, thereby suppressing the blue stray light to the maximum. When ultraviolet irradiation or the like is necessary during the production process of the optical component, the surface may be made to have a transmission of 20% or more for the light having a wavelength of 350 to 375 nm.

The optical component of the invention will be specifically described below with reference to FIG. 1.

FIG. 1 shows an example in which an inorganic multilayer film is formed on a surface on a light incident side and a light exit side of a polarization hologram 10 with a phase plate, and is a cross-sectional view thereof. In FIG. 1, a first transparent substrate 1 and a second transparent substrate 2 sandwich and hold therebetween a concave-convex portion 5 comprising a polymer liquid crystal, a filling adhesive 7 for filling the concave-convex and a phase plate 6 having a retardation corresponding to ¼ of a wavelength used. Here, the concave-convex portion 5 has optical anisotropy, and has an extraordinary refractive index in a direction parallel to the substrate. The refractive index of the filling adhesive 7 and the ordinary refractive index of the concave-convex portion 5 approximately agree with each other at a wavelength used of the polarization hologram. By taking such a constitution, the concave-convex portion 5 and the filling adhesive 7 form a polarization diffraction grating portion. That is, when light polarized in a direction of the ordinary refractive index of the concave-convex portion 5 enters the polarization diffraction grating portion of the polarization hologram 10 with a phase plate, it passes therethrough without being diffracted, and when light polarized in a direction of the extraordinary refractive index of the concave-convex portion 5 enters, it is diffracted.

Further, an inorganic optical multilayer film 4 comprising an inorganic material is formed on the whole surface of the second transparent substrate 2, on the side opposite to the concave-convex portion 5. The formation of the optical multilayer film 4 reduces the intensity of light of 400 to 410 nm which enters the second transparent substrate 2 to 20% or less of that of light which enters each optical multilayer film. Furthermore, for light having a wavelength of 600 to 800 nm which enters the second transparent substrate 2, 60% or more of the intensity of light which enters each optical multilayer film is secured.

Further, for light having a wavelength of 350 to 375 nm which enters the first transparent substrate 1, a transmission of 20% or more is secured, so that ultraviolet irradiation necessary during the production process of the optical component can be performed through this surface. In addition, an optical multilayer film 3 comprising an inorganic material is formed on the whole surface of the first transparent substrate 1, on the side opposite to the concave-convex portion 5, thereby performing reflection prevention at a wavelength used of the optical component.

A function at the time when the optical component of the invention shown in FIG. 1 is incorporated in an optical head device will be described below with reference to FIG. 4. In FIG. 4, an example of a two-wavelength compatible optical head device for a DVD and a BD is shown for brevity. However, it is easy for one skilled in the art to modify it to a three-wavelength compatible optical head device by adding an optical system for a CD. Further, although the example shown is the case of an objective lens which shares two wavelengths for a DVD and a BD, separate objective lenses may also be used.

Light emitted from a blue laser source 90 is circularly polarized by a blue color phase plate 120 serving as a ¼ wavelength plate through a blue color collimater lens 80 and a blue color polarization hologram 110, deflected to a direction of an objective lens 40 by a dichroic prism 30, and irradiated to an optical disc 50 through the objective lens 40. The blue light irradiated is reflected by the optical disc 50 and, at the same time, circularly polarized in an opposite-handed direction, then, via the objective lens 40 and the dichroic prism 30, made to be polarized light having a polarization component in a direction perpendicular to the direction at the time of irradiation to the optical disc 50 by the blue color phase plate 120, diffracted by the blue color polarization hologram 110, and detected by a blue color light detector 100.

On the other hand, light emitted from a DVD laser source 70 enters a polarization hologram 10 having a phase plate of FIG. 1 through a collimater lens 20 for a DVD, circularly polarized by the phase plate 6, and irradiated to the optical disc through the dichroic prism 30 and the objective lens 40. DVD light irradiated is reflected by the optical disc 50 and, at the same time, circularly polarized in an opposite-handed direction, enters again the phase plate-having polarization hologram 10 of FIG. 1 through the objective lens 40 and the dichroic prism 30, becomes polarized light having a polarization component in a direction perpendicular to the direction at the time of irradiation to the optical disc 50 by the phase plate 6, is diffracted by the polarization diffraction grating portion of the phase plate—having polarization hologram 10, and is detected by a DVD light detector 60.

At this time, the blue stray light originated from the blue laser source 90 occurs, and enters the phase plate—having polarization hologram 10. However, as described above, the blue stray light is blocked by the optical multilayer film 4 provided on the phase plate—having polarization hologram 10 to suppress deterioration of the organic materials constituting the phase plate—having polarization hologram 10, such as the concave-convex portion 5 and the filling adhesive 7.

### EXAMPLES

The invention will be illustrated in accordance with examples, but the invention should not be construed as being limited thereto.

This example is a specific example of an embodiment of an optical component of the invention. First, an optical multilayer film 3 is formed on a surface of a first transparent substrate 1 made of glass on the air side by using a vacuum deposition method. As the glass, B270-Superwite manufactured by SCHOTT AG was used. The optical multilayer film 3 has functions of preventing reflection of incident light having respective wavelengths of 395 to 415 nm, 645 to 675 nm and 770 to 800 nm and blocking UV light of 310 nm or less. The thickness of respective layers of the optical multilayer film is shown in Table 1. The transmission of this substrate is 1% or less in the wavelength range of from 200 to 310 nm, 99% or more in the wavelength of 395 to 415 nm (at a wavelength of 405 nm, 99.8%; reflection being 0.2%), 99% or more in the wavelength of 645 to 675 nm (99.8% at 660 nm), and 99% or more in the wavelength of 770 to 800 nm (99.8% at 785 nm). The transmission of the substrate itself is 98% or more, and these transmissions can be approximately regarded as the transmission of the optical multilayer film.

TABLE 1

| | | Physical Film |
|---|---|---|
| Layer | Material | Thickness (nm) |
| 1 | SiO₂ | 105.1 |
| 2 | Ta₂O₅ | 23.2 |
| 3 | SiO₂ | 38.8 |
| 4 | Ta₂O₅ | 55.3 |
| 5 | SiO₂ | 44.2 |
| 6 | Ta₂O₅ | 20.9 |
| 7 | SiO₂ | 49.4 |
| 8 | Ta₂O₅ | 33.6 |
| 9 | SiO₂ | 47.5 |
| 10 | Ta₂O₅ | 22.9 |
| 11 | SiO₂ | 39.9 |
| 12 | Ta₂O₅ | 39.1 |
| 13 | SiO₂ | 50.9 |
| 14 | Ta₂O₅ | 23.4 |
| 15 | SiO₂ | 50.1 |
| 16 | Ta₂O₅ | 18.8 |
| Substrate | Glass | |
| | Total Film | 663.1 |
| | Thickness | |

Subsequently, an optical multilayer film 4 is formed on a surface of a second transparent substrate 2 made of glass on the air side by using a vacuum deposition method. As the glass, B270-Superwite manufactured by SCHOTT AG was used. The optical multilayer film 4 has functions of blocking light having a wavelength of 395 to 415 nm and preventing reflection of incident light having respective wavelengths of 640 to 690 nm and 760 to 800 nm to increase the transmission. The thickness of respective layers of the optical multilayer film is shown in Table 2. The transmission of this substrate with the optical multilayer film is 1% or less in the wavelength of from 395 to 415 nm (0.5% at a wavelength of 405 nm), 99% or more in the wavelength of 640 to690 nm (99.8% at 660 nm), 99% or more in the wavelength of 760 to 800 nm (99.8% at 660 nm), and 99% or more in the wavelength of 760 to 800 nm (99.8% at 785 nm). The transmission of the substrate itself is 98% or more, and these transmissions can be approximately regarded as the transmission of the optical multilayer film.

TABLE 2

| | | Physical Film |
|---|---|---|
| Layer | Material | Thickness (nm) |
| 1 | SiO₂ | 140.4 |
| 2 | Ta₂O₅ | 51.3 |
| 3 | SiO₂ | 62.6 |
| 4 | Ta₂O₅ | 41.6 |
| 5 | SiO₂ | 71.3 |
| 6 | Ta₂O₅ | 48.5 |
| 7 | SiO₂ | 69.9 |
| 8 | Ta₂O₅ | 42.6 |
| 9 | SiO₂ | 74.4 |
| 10 | Ta₂O₅ | 45.3 |
| 11 | SiO₂ | 63.5 |
| 12 | Ta₂O₅ | 43.8 |
| 13 | SiO₂ | 76.4 |
| 14 | Ta₂O₅ | 51.8 |
| 15 | SiO₂ | 63.4 |
| 16 | Ta₂O₅ | 35.6 |
| Substrate | Glass | |
| | Total Film | 982.5 |
| | Thickness | |

Then, a phase plate 6 formed of a polycarbonate is laminated on the second transparent substrate 2. The phase plate is prepared so that the retardation thereof corresponds to λ/4 to a wavelength used.

Further, a liquid crystal monomer is uniformly applied to the first transparent substrate made of glass, and polymerized by irradiation of UV light to form a polymer liquid crystal film having birefringence. As the liquid crystal monomer, the polymerizable composition described in JP-A-2001-220583, which contains a compound having —Ph—CO— or tolan is used. At this time, the orientation direction of liquid crystal molecules is selected so as to be perpendicular to the paper plane, and coating conditions are determined so as to give a thickness of 11.6 μm. The ordinary refractive index and the extraordinary refractive index of this polymer liquid crystal film at a wavelength of 660 nm are 1.545 and 1.765, respectively. The ordinary refractive index and the extraordinary refractive index at a wavelength of 785 nm are 1.538 and 1.753, respectively. This polymer liquid crystal film is processed by using techniques of photolithography and etching so as to form a concave-convex portion 5 being of step grating form in cross section.

Then, the second transparent substrate 2 on which the phase plate 6 was laminated was adhered by using an UV-curable filling adhesive 7 so as to fill the concave-convex portion 5 comprising the polymer liquid crystal of the first transparent substrate 1. At this time, as the filling adhesive 7, there is selected one having a refractive index of 1.545 at a wavelength of 660 nm and a refractive index of 1.536 at a wavelength of 785 nm. UV curing was performed by irradiation of a mercury lamp from the first transparent substrate side.

When the phase plate-having polarization hologram of this example thus prepared is irradiated with blue stray light having a wavelength of 405 nm, the blue stray light is blocked by the optical multilayer film 4, and does not enter the inside of the element. Accordingly, the polymer liquid crystal can be protected from the blue stray light.

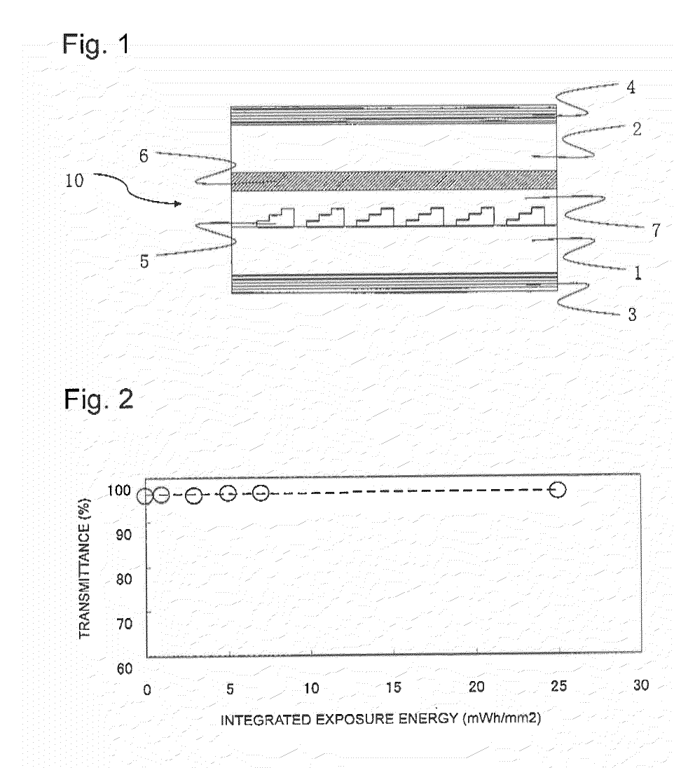

For this phase plate-having polarization hologram, a blue laser beam exposure experiment was made from the side of the second transparent substrate 2 under experimental conditions of a temperature of 80° C. and an integrated exposure energy of 25 mWh/mm². The transmittance of ordinary light of the laser beam at a wavelength of 660 nm before the experiment is 96.3%, and the transmittance of ordinary light of the laser beam at a wavelength of 660 nm after the experiment is 96.4%, which does not vary from the transmittance of light before the experiment. The results are shown in FIG. 2.

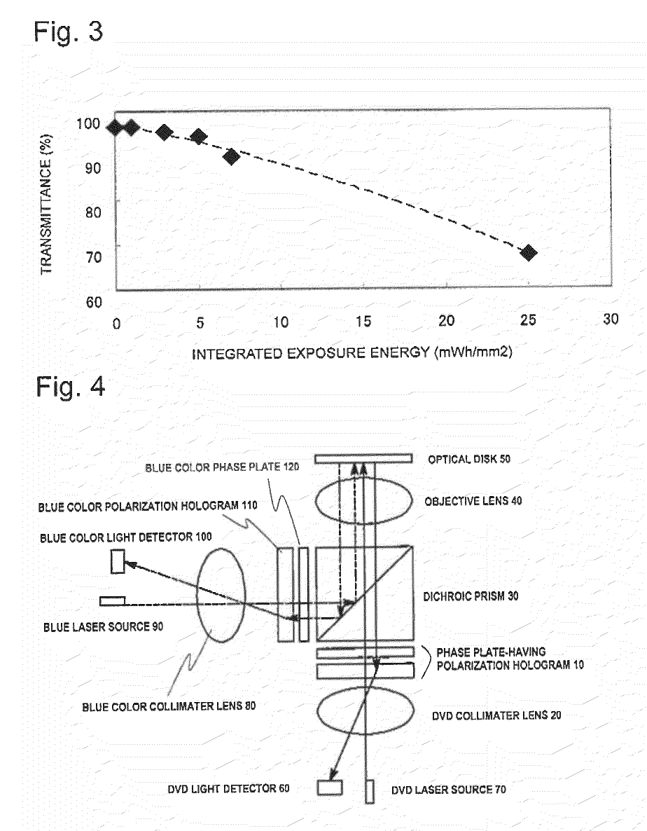

When an optical component is prepared in the same manner as in the above-mentioned example with the exception that the optical multilayer film 4 formed on the substrate is replaced with an antireflective film not having a function of blocking blue light but having a four-layer constitution for incident light having wavelengths of 645 to 675 nm and 770 to 800 nm, and the same blue laser beam exposure experiment is made, then the transmittance of the laser beam at a wavelength of 660 nm before the experiment is 96.2%, and the transmittance of the laser beam at a wavelength of 660 nm after the experiment is 67.5%. Compared to the transmittance before the experiment, an approximately 28% decrease is observed in the transmittance after the experiment. The results are shown in FIG. 3.

While the invention has been described in detail and with reference to specific embodiments thereof, it will be apparent to one skilled in the art that various changes and modifications can be made therein without departing from the spirit and scope of the invention.

This application is based on Japanese Patent Application 2006-175461 filed on Jun. 26, 2006, the contents of which are incorporated herein by reference.

### INDUSTRIAL APPLICABILITY

It is useful to use the optical component of the invention in an optical head device compatible with a plurality of wavelengths including a BD, particularly in a light path of a laser beam for reproducing and recording a CD and a DVD of a three-wavelength compatible optical head device for a CD, a DVD and a BD.

1. An optical component for a laser beam at least partially comprising an organic material, and having, provided over a substantially whole surface of at least one light incident face, a blue light blocking means that has a transmission of light having a wavelength of 400 to 410 nm of 20% or less and a transmission of light having a wavelength of 600 to 800 nm of 60% or more.

2. An optical component for a laser beam at least partially comprising an organic material, and having, provided over a substantially whole surface of at least one light incident face, a blue light blocking means that has a transmission of light having a wavelength of 400 to 410 nm of 20% or less and a transmission of light having wavelengths of 640 to 690 nm and 760 to 800 nm of 60% or more.

3. The optical component for a laser beam according to claim 1, wherein the blue light blocking means has a transmission of light having a wavelength of 400 to 410 nm of 20% or less over a substantially whole surface of at least one light incident face, and the surface opposite to the light incident face has a transmission of light having a wavelength of 400 to 410 nm of 60% or more.

4. The optical component for a laser beam according to claim 1, wherein the blue light blocking means is provided in contact with the light incident face of the optical component for a laser beam.

5. The optical component for a laser beam according to claim 4, wherein the blue light blocking means is an inorganic multilayer film provided in contact with the light incident face of the optical component for a laser beam.

6. The optical component for a laser beam according to claim 1, wherein the organic material contained in the optical component for a laser beam is a polymer liquid crystal.

7. The optical component for a laser beam according to claim 1, wherein at least one light incident face different from the light incident face on which the blue light blocking means is provided has a transmission of light having a wavelength of 350 to 375 nm of 20% or more.

8. The optical component for a laser beam according to claim 1, wherein the optical component for a laser beam is a hologram.

9. The optical component for a laser beam according to claim 1, wherein the optical component for a laser beam is used as an optical system of an optical head device using a laser beam having a wavelength of 400 to 410 nm and a laser beam having a wavelength of 600 nm or more, and arranged at a portion in an optical path of the laser beam having a wavelength of 600 nm or more and outside an optical path of the laser beam having a wavelength of 400 to 410 nm.

10. The optical component for a laser beam according to claim 2, wherein the blue light blocking means has a transmission of light having a wavelength of 400 to 410 nm of 20% or less over a substantially whole surface of at least one light incident face, and the surface opposite to the light incident face has a transmission of light having a wavelength of 400 to 410 nm of 60% or more.

11. The optical component for a laser beam according to claim 2, wherein the blue light blocking means is provided in contact with the light incident face of the optical component for a laser beam.

12. The optical component for a laser beam according to claim 11, wherein the blue light blocking means is an inorganic multilayer film provided in contact with the light incident face of the optical component for a laser beam.

13. The optical component for a laser beam according to claim 2, wherein the organic material contained in the optical component for a laser beam is a polymer liquid crystal.

14. The optical component for a laser beam according to claim 2, wherein at least one light incident face different from the light incident face on which the blue light blocking means is provided has a transmission of light having a wavelength of 350 to 375 nm of 20% or more.

15. The optical component for a laser beam according to claim 2, wherein the optical component for a laser beam is a hologram.

16. The optical component for a laser beam according to claim 2, wherein the optical component for a laser beam is used as an optical system of an optical head device using a laser beam having a wavelength of 400 to 410 nm and a laser beam having a wavelength of 600 nm or more, and arranged at a portion in an optical path of the laser beam having a wavelength of 600 nm or more and outside an optical path of the laser beam having a wavelength of 400 to 410 nm.
